(19) United States
(12) Patent Application Publication
(10) Pub. No.: US 2011/0098371 A1
(43) Pub. Date: Apr. 28, 2011

(54) Proton-Conducting Polymeric Poly(Arylene Ether)s with Pendant Phenyl Sulfonic Acids

(75) Inventors: Dae Sik Kim, Los Alamos, NM (US); Michael D. Guiver, Ottawa (CA)

(73) Assignee: NATIONAL RESEARCH COUNCIL OF CANADA, Ottawa, ON (CA)

(21) Appl. No.: 13/000,444

(22) PCT Filed: Jul. 3, 2009
(86) PCT No.: PCT/CA2009/000925

§ 371 Date: Dec. 21, 2010

Related U.S. Application Data
(60) Provisional application No. 61/129,575, filed on Jul. 7, 2008.

(51) Int. Cl. C08G 75/24; C08G 65/38

(52) U.S. Cl. 521/27; 528/173; 528/174; 521/25

(57) ABSTRACT

Disclosed are sulfonated polymers of formula (I) or a salt thereof: wherein X is (a) or (b), R is hydrogen or an organic moiety, n is an integer from 10 to 10,000, p is 1 or 2, and m is 0 or 1 for a particular monomer unit such that the polymer has a degree of sulfonation of 0.50 or greater. Such polymers are useful in proton exchange membranes (PEMs) having high ion exchange capacity with higher proton conductivity than Nafion™, while having lower methanol permeability and lower water uptake than previously disclosed polymers.

### CROSS-REFERENCE TO RELATED APPLICATIONS

This application claims the benefit of U.S. Provisional Patent Application 61/129,575 filed Jul. 7, 2008 and is a continuation-in-part of U.S. patent application Ser. No. 12/309,359 filed Jan. 15, 2009, the entire contents of each of which are hereby incorporated by reference.

### FIELD OF THE INVENTION

The present invention is related to highly fluorinated or nitrile-containing copoly(arylene ether)s with pendent sulfonic acid phenyl groups, methods of preparation thereof, and uses thereof in proton exchange membranes.

### BACKGROUND OF THE INVENTION

Fuel cells are being pushed toward the brink of commercialization because they offer the potential of long operating lifetimes and the ability to refuel rather than recharge, as in the case of batteries typically used in portable power applications.¹ Extensive efforts have been made to develop alternative hydrocarbon-based polymer electrolyte membranes to overcome the drawbacks of the current widely used perfluorosulfonic acid Nafion™.²⁻³ Sulfonated derivatives of poly(arylene ether)s such as poly(arylene ether sulfone) (PES), poly(arylene ether ether ketone) (PEEK), poly(arylene ether nitrile) (PAEN) are considered to be some of the more promising routes to high performance PEMs because of their well-known oxidative and hydrolytic stability in the fuel cell environment and because of the relatively easy access to a variety of different structures, allowing optimization and tailoring of properties. Usually, sulfonated aromatic polymers can be obtained either by post-sulfonation or by direct copolymerization of a sulfonated monomer. Sulfonated aromatic polymers can be divided into two types, according to the attachment site of the sulfonic acid groups, main-chain-type and side-chain-type.⁴⁻⁶ Ionomers with sulfonic acid groups attached directly to their main chain often show an intensive water uptake over a critical temperature or degree of sulfonation (DS), resulting in unfavorable excess water swelling of the membranes. Kreuer et al⁷ reported that these sulfonated polymers are unable to form defined hydrophilic domains, as the rigid polyaromatic main chain prevents continuous ionic clustering from occurring. One promising way to enhance properties in terms of PEM performance is to distinctly separate the hydrophilic sulfonic acid group regions from the hydrophobic polymer main chain by locating the sulfonic acid groups on side chains grafted onto the polymer main chain.8 In our previous report, a series of these pendant or comb-type copolymers show the reasonable performance compared to Nafion™ membranes.⁸⁻¹¹

Several research groups reported that alternative PEM materials show good direct methanol fuel cell (DMFC) performance compared to Nafion™.¹²⁻¹⁵ However, it has been suggested that insufficient membrane/electrode contact limits performance due to increased ohmic resistance. Kim and Pivovar reported that dimensional mismatch (due to differences in water uptakes) between the membrane and Nafion™-bonded electrodes resulted in interfacial performance losses and poor long-term stability, likely due to membrane-electrode delamination.^{16,17} Interfacial losses and long-term stability were improved by tuning water uptake of the PEMs to better match the characteristics of the electrodes.

Fluorinated poly(arylene ether)s developed for interlayer dielectric materials may be considered as good candidate materials for the PEM polymer main chain, due to their excellent thermal stability, good mechanical properties, high hydrophobicity and economic price.¹⁸⁻²⁰ The presence of the perfluorophenylene units in the main chains imparts excellent mechanical strength as well as good thermal and chemical stabilities, while the presence of ether groups imparts flexibility, facilitating their processability.

Previous studies indicated that sulfonated polynitriles exhibited reduced water uptake compared with sulfonated polysulfones or polyketones, when compared at similar ion exchange capacity (IEC).²¹ In addition, the incorporation of nitrile groups into polymer structures is thought to be beneficial for promoting adhesion of polymeric matrices to inorganic fillers in composite membranes.²² We previously reported copoly(arylene ether nitrile)s having high performance in DMFC.²³

There remains a need for improved PEM materials for application in DMFC and PEMFC having high IEC and proton conductivities, while having acceptable water uptake.

### SUMMARY OF THE INVENTION

The present invention provides PEM materials designed to minimize water uptake and methanol permeability while retaining high IEC values and proton conductivities. Polymers containing pendant phenyl sulfonated groups allow distinct separation between the hydrophilic regions and the hydrophobic polymer main chain. Incorporation into such polymers of either a highly hydrophobic fluoroaromatic backbone, to accentuate nanophase separation of the domains, or nitrile groups that limit swelling through polar interchain interactions further results in minimizing water uptake and/or, methanol permeability. Polymers containing pendant phenyl sulfonated groups and having either a highly hydrophobic fluoroaromatic backbone or nitrile groups incorporated therein have been found to have surprisingly improved PEM properties over polymers previously disclosed, for example, the polymers previously disclosed in International Patent Application PCT/CA2007/001229. Polymers of the present invention have high IEC with higher proton conductivity than Nafion™, while having lower methanol permeability and lower water uptake than previously disclosed polymers.

Thus, there is provided a sulfonated polymer of formula (I) or a salt thereof:

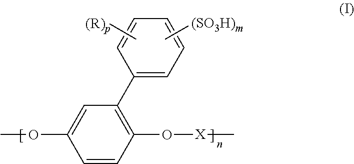

wherein X is

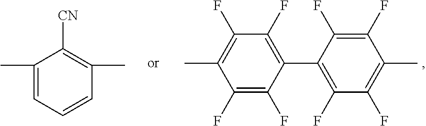

R is hydrogen or an organic moiety, n is an integer from 10 to 10,000, p is 1 or 2, and m is 0 or 1 for a particular monomer unit such that the polymer has a degree of sulfonation of 0.50 or greater.

The organic moiety may be the same or different and is preferably a substituted or unsubstituted C₁-C₈ alkyl, C₆-C₁₈ aryl, C₇-C₂₆ aralkyl, C₇⁻0₂₆ alkaryl, C₁-C₈ alkoxy, C₆-C₁₈ aryloxy group. The organic moiety may be substituted by one or more substituents, for example, halogens (e.g. F, Cl, Br, I), amines, amides, hydroxyl. The organic moiety may be, for example, methyl, ethyl, n-propyl, i-propyl, n-butyl, s-butyl, t-butyl, trifluoromethyl, phenyl, methoxy, phenoxy.

Preferably, R is hydrogen or a ring-activating organic moiety. Ring-activating organic moieties include, for example, unsubstituted alkyl, aryl, aralkyl, alkaryl, alkoxy and aryloxy groups. Preferably, the ring-activating organic moiety is an unsubstituted C₁-C₈ alkyl (e.g. methyl, ethyl, n-propyl, i-propyl, n-butyl, s-butyl, t-butyl), aryloxy (e.g. phenoxy) or aryl (e.g. phenyl) group. More preferably, R is hydrogen.

The value of m may be 0 or 1 for a particular monomer unit in the polymer. When m is 1 for all monomer units, the degree of sulfonation (DS) for the polymer is 1.00. If m is 1 for 50% of all the monomer units, the degree of sulfonation for the polymer is 0.50. The degree of sulfonation is preferably 0.55 or greater, more preferably 0.60 or greater, even more preferably 0.64 or greater. For monomer units in which m is 1, the —SO₃H group is preferably in para position on the pendant phenyl ring in relation to the polymer backbone.

Preferably, the polymers of the present invention have a number average molecular weight (Mn) in a range of from about 1,000 to about 1,000,000, more preferably from about 5,000 to about 500,000. They may be prepared by post-sulfonation of an appropriate poly(arylene ether) or poly(arylene ether nitrile), or by pre-sulfonation of one or more monomers followed by polymerization of the monomers. Polymerization processes to produce such polymers are well known in the art. Phenyl-containing polymers may be readily prepared by one-step polymerization from commercially available monomers.

Sulfonated monomers and growing sulfonated polymer chains sometimes have problems with limited solubility. However, high molecular weight polymers may be produced by polymerizing non-sulfonated monomers. In the present invention, sulfonation is preferably effected after polymerization, therefore, high molecular weight sulfonated polymers may be readily produced. In general, high MW polymers give better properties for PEMFC and DMFC. In the present invention, two different types of sulfonated copolymers were prepared by mild post-sulfonation of poly(arylene ether)s (sPAE) with high fluorine content and poly(arylene ether nitrile)s (sPAEN) with high nitrile content, using chlorosulfonic acid. The membrane properties of these novel sulfonated copolymers, such as thermal properties, water uptake, proton conductivity, and methanol permeability, were also investigated for future DMFC application.

Sulfonation may be accomplished by any suitable means. For poly(arylene ether)s or poly(arylene ether nitrile)s (or monomers thereof) that are difficult to sulfonate, rigorous reaction conditions may be required (e.g. strong sulfonation reagent (fuming sulfuric acid, sulfur trioxide or chlorosulfonic acid), high temperature, long reaction time etc.). However, in the present invention, the pendent phenyl group provides an opportunity to produce sulfonated polymers under mild sulfonation conditions. Where the pendent phenyl group is unsubstituted or substituted by a ring-activating moiety, the phenyl ring is sufficiently activated that mild sulfonation conditions selectively sulfonate the pendent phenyl ring with one sulfonic acid (sulfonate) group. This provides the ability to more precisely control the sulfonation content (SC) of the sulfonated polymer, thereby tuning the properties of PEMs that comprise the sulfonated polymer. Mild sulfonation conditions include, for example, the use of concentrated sulphuric acid (e.g. 95-98%) at room temperature (e.g. 20-30° C.) for several hours, or the use of chlorosulfonic acid for a shorter reaction time. Sulfonation conditions should not cause extensive polymer chain degradation in order not to jeopardize mechanical properties of the sulfonated polymer.

Polymers of the present invention are useful in proton exchange membranes (PEMs). PEMs cast from these polymers may have one or more of the following attractive properties: high ion exchange capacity (IEC); low methanol permeability; low water uptake; high proton transport to enable the passage of high currents with low resistance; high thermal, dimensional and chemical stability; mechanical strength and film integrity for thin films in both dry and hydrated states; operational temperatures up to 140° C.; low gas and fuel crossover properties; low-cost materials and environmental compatibility; and, easy preparation and suitable for scale-up. Proton exchange membranes comprising polymers of the present invention are useful in fuel cells, water electrolyzers, ion exchange membranes, components of bipolar membranes, etc., particularly in fuel cells. Fuel cells include, for example, direct methanol fuel cells (DMFC) and hydrogen fuel cells (PEMFC). Polymers of the present invention are also useful as ionomer catalyst binders, particularly in fuel cells.

Polymers of the present invention advantageously may have methanol permeabilities of about 1.0×10⁻⁶ cm²/s or less. The polymers may advantageously have relative selectivities (ratio of relative proton conductivity to relative methanol permeability) of about 2.0 or greater, more preferably about 3.0 or greater. The polymers may advantageously have a water uptake (WU) of about 45 wt % or less at 80° C. The polymers may advantageously have a water uptake-based selectivity (ratio of relative proton conductivity at 80° C. to relative water uptake (wt % based) at 80° C.) of from about 0.75 to about 1.0. The polymers may advantageously have proton conductivities at 30° C. of about 60 mS/cm or greater, more preferably about 65 mS/cm or greater, even more preferably about 68 mS/cm or greater. The polymers may advantageously have proton conductivities at 80° C. of about 80 mS/cm or greater, more preferably about 130 mS/cm or greater, even more preferably about 135 mS/cm or greater. The polymers may advantageously have a combination of two or more of the above properties, for example, a water uptake of about 45 wt % or less at 80° C. and a proton conductivity of about 80 mS/cm or greater at 80° C.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 depicts ¹H NMR spectra of sulfonated poly(arylene ether) copolymers;

FIG. 2 depicts ¹H NMR spectra of sulfonated poly(arylene ether nitrile) copolymers;

FIG. 3 depicts a graph of TGA curves of copolymers under N₂ atmosphere;

FIG. 4 depicts a graph of stress vs. strain curves of sulfonated copolymers in the dry state;

FIG. 5 depicts a graph of proton conductivity as a function of temperature (° C.);

FIG. 6 depicts a graph of relative proton conductivities as a function of relative methanol permeabilities at 30° C. [ref. 11];

FIG. 7 depicts a graph of proton conductivities and water uptake (wt. %) at 80° C. [refs. 8, 9, 11, 20, 22, 23, 24, 30-35], where sPAEK-BP data from ref. 24 and data for Ph-SPEEKK and Ph-SPEEKDK [ref. 11] were re-measured under identical conditions to the present series;

FIG. 8 depicts a graph of proton conductivities and water uptake (vol. %) at 80° C. [refs. 8, 9, 11, 20, 22, 23], where data for Ph-SPEEKK and Ph-SPEEKDK [ref. 11] were re-measured under identical conditions to the present series; and,

FIG. 9 depicts a graph of relative water uptake (vol. %) versus relative proton conductivity for hydrocarbon PEMs [refs. 8, 9, 11, 20, 22, 23].

### DESCRIPTION OF PREFERRED EMBODIMENTS

### Materials:

Monomers 2-phenylhydroquinone (PHQ), decafluorobiphenyl (DFBP), and 2,6-difluorobenzonitrile (DFBN) were purchased from Sigma-Aldrich Ltd. 2-Phenylhydroquinone (PHQ) was recrystallized from toluene before use. Dimethylacetamide (DMAc) (Sigma-Aldrich) was vacuum distilled prior to use. All other chemicals such as methylene chloride, chlorosulfonic acid, and methanol were reagent grade from Sigma-Aldrich and were used as received.

### Copolymerization of Poly(Arylene Ether)s:

In a typical PAE reaction, 10 mmol PHQ, 10 mmol DFBP, and 12 mmol K₂CO₃ were added into a three-neck flask equipped with a magnetic stirrer, a Dean-Stark trap, and an N₂ gas inlet. Then, 15 mL DMAc and 15 mL of toluene were charged into the reaction flask. The reaction mixture was heated to 80° C. The polymerization was complete after 6 h. The mixture was coagulated into a large excess of methanol with vigorous stirring. The resulting fibrous copolymer was washed thoroughly with water several times and dried under vacuum at 100° C. for 24 h. This copolymer was denoted PAE.

Poly(arylene ether nitrile) copolymer was prepared using the same synthesis and purification routine using difluorobenzonitrile (DFBN) and 2-phenylhydroquinone (PHQ) at 170° C. This copolymer was denoted PAEN.

The reaction procedure is generally shown in Scheme 1 and may be generalized for 2-phenylhydroquinone (PHQ) derivatives having substituents on the pendant phenyl group. Further, difluorobenzonitrile (DFBN) may be replaced by dichlorobenzonitrile (DCBN) which is less reactive but less expensive. Furthermore, dimethylacetamide (DMAc) may be replaced by or used together with another suitable aprotic solvent for polycondensation reactions, for example, N-methylpyrrolidone (NMP), dimethylformamide (DMF), sulfolane, diphenylsulfone and dimethylsulfoxide (DMSO) or a mixture thereof.

### Sulfonation of Poly(Arylene Ether)s Copolymer.

A typical procedure for the sulfonation of the poly(arylene ether)s copolymers was as follows.²⁴ To a solution of polymer (10 mmol) in methylene chloride, chlorosulfonic acid (2 mL) in methylene chloride was added dropwise at room temperature. The resulting mixture was stirred vigorously until a dark brown product precipitated out of the solution. The precipitates were washed with water and ice several times and dried overnight under a vacuum at 80° C. The reaction procedure is shown in Scheme 1 and may be generalized for 2-phenylhydroquinone (PHQ) derivatives having substituents on the pendant phenyl group.

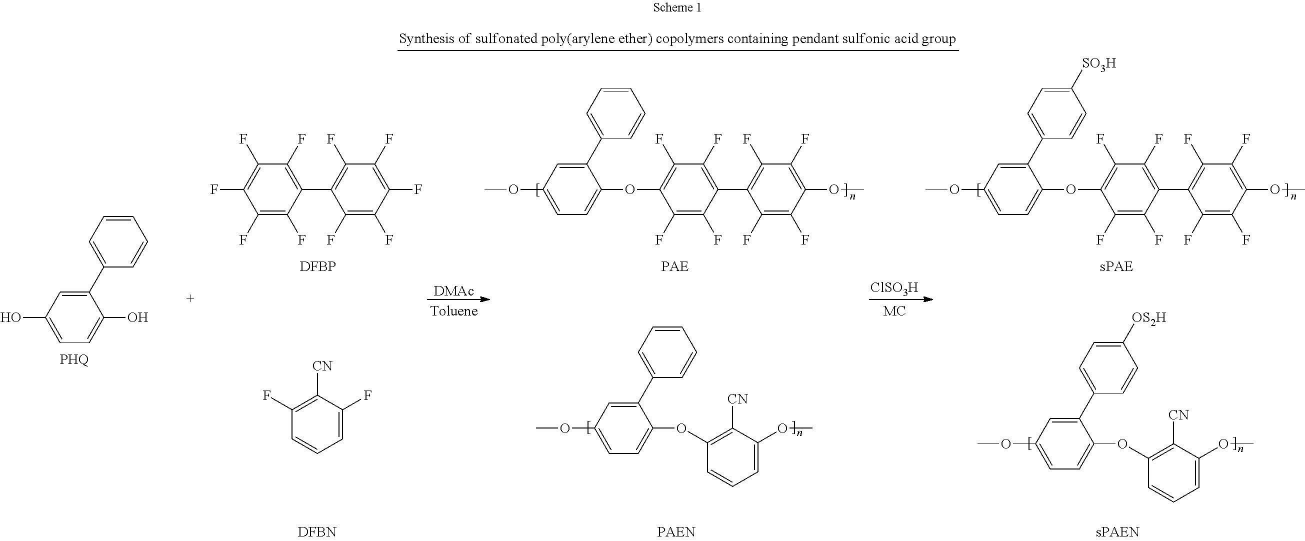

### Measurements:

NMR spectra were recorded in DMSO-d₆ or chloroform-d using a Varian Unity Inova™ spectrometer at a resonance frequency of 399.96 MHz for ¹H. Signals from DMSO-d₆ and chloroform-d were used as the reference for ¹H (2.50 ppm (DMSO), 7.25 ppm (Chloroform).

Thermal gravimetric analysis (TGA) was performed using a TA instruments TGA 2950 at a heating rate of 10° C./min under a nitrogen atmosphere (60 mL/min). Polymer samples for TGA analysis were preheated at 150° C. for 40 min under a nitrogen atmosphere to remove moisture.

Proton conductivities of the membranes were estimated from AC impedance spectroscopy data using a Solartron™ 1260 gain phase analyzer. Each specimen was measured in water, mounted in a cell that was temperature controlled and open to the air by a pinhole. Each end of the membrane strip was clamped in a frame between two platinum wire electrodes. The conductivity (σ) of the samples in the longitudinal direction was calculated, using the relationship σ=L/(R×d×W) where L is the distance between the electrodes, d and W are the thickness and width of the sample stripe respectively. R was derived from the low intersect of the high frequency semi-circle on a complex impedance plane with the Re (Z) axis. The impedance of each sample was measured five times to ensure data reproducibility.

Methanol permeability was measured using a simple two compartment glass diffusion cell. A membrane (2 cm×2 cm) was placed between two silicone rubber gaskets and with the two compartments clamped together around the gaskets. The active area of the membrane was 1.757 cm². Compartment A was filled with 100 mL of 10% v/v (2.47 M) methanol with an internal standard of 0.2% v/v (0.022 M) 1-butanol in aqueous solution. Compartment B was filled with 100 mL of 0.2% v/v 1-butanol solution. The diffusion cell was placed in a water bath held at 30° C. and each compartment was stirred by a separate stir plate to ensure uniform stirring. Methanol concentrations were determined by ¹H NMR spectroscopy.

Mechanical properties of the thin dry membranes were evaluated at room temperature on an Instron™ 5565 instrument at a strain rate of 10 mm/min, and a 500 N load cell was used. The samples were prepared by cutting into a standard dumbbell shape using a press (DIN-53504-S3A).

### Characterization Methods:

Density of membrane was measured from a known membrane dimension and weight after drying at 100° C. Water uptake was measured after drying the membrane in acid form at 100° C. under vacuum overnight. The dried membrane was immersed in water at 30° C. and periodically weighed on an analytical balance until a constant water uptake weight was obtained. Then, the volume based water uptake (WU) was obtained. The IEC_{W} was measured using a typical titration method. Sulfonated polymer in powder form was used when the IEC_{W} was measured experimentally. A volume based IEC (IEC_{V}) was obtained by multiplying the membrane density by the IEC_{W} values. This calculation resulted in IEC_{V} (dry) based on the dry membrane density. An IEC_{V} (wet) was then calculated based on membrane water uptake (vol %).

### Results and Discussion:

Copolymerization of Sulfonated Poly(arylene ether) (sPAE and sPAEN)

The poly(arylene ether) copolymers PAE and PAEN containing pendant phenyl rings were synthesized by polycondensation reaction. The polymerization reactions of PAE using DFBP and PHQ proceeded easily, and no cross-linking was evident when the temperature was well controlled by an oil bath (not exceeding 80° C.). with a reaction time of less than 6 h. It was found that higher temperature and longer reaction times resulted in some cross-linked gel-like polymer, indicating that the fluorine of DFBP is reactive under these conditions when using K₂CO₃. In the synthesis of PAEN using DFBN and PHQ, the reaction temperature and reaction time were controlled by an oil bath at less than 170° C. and less then 10 h.

Sulfonation is an electrophilic substitution reaction and the substitution of the sulfonic acid group depends on the substituents present on the ring. It is well-known that benzene rings substituted with strong electron-withdrawing groups such as carbonyl and sulfone are deactivated towards electrophilic sulfonation. However, rigorous sulfonation conditions, such as high reaction temperatures, long reaction time, and strong sulfonation reagents, may lead to degradation of the polymer chain and a resulting loss of mechanical strength. Therefore, it is very important to carefully control the reaction conditions for introducing sulfonic acid group onto the pendant phenyl rings without adverse side reactions. In this study, the copolymers were sulfonated with chlorosulfonic acid in methylene chloride at room temperature. The sulfonated polymers were precipitated out of the solution after a sulfonation reaction time of 30 min. As shown in Table 1, the sulfonation reaction time in the present sulfonation reactions was controlled from 10 to 30 min, with no evidence of chain degradation occurring under these conditions. It was found that only with extended reaction times using chlorosulfonic acid, some degradation of the polymer chain and a resulting loss of mechanical strength would occur in these copolymer systems. This degradation that occurred from extended sulfonation reaction times (not used) was evident in both sPAE and sPAEN. The DS (degree of sulfonation) controlled by the sulfonation time was determined quantitatively using ¹H NMR spectroscopic measurements. The sulfonated copolymer was denoted sPAE(N) xx, where xx refers to the DS.

TABLE 1
Properties of Membranes

| | Sulfonation | | η | T_{d(5%)} |
|---|---|---|---|---|
| Copolymer | time (min) | DS^{a} | (dL/g)^{b} | (° C.)^{c} |
| PAE | 0 | 0 | 1.32 | 525.7 |
| sPAE 0.55 | 10 | 0.55 | 1.46 | 404.7 |
| sPAE 0.64 | 15 | 0.64 | 1.58 | 389.2 |
| sPAE 1.00 | 30 | 1.00 | 1.72 | 373.8 |
| PAEN | 0 | 0 | 1.43 | 501.5 |
| sPAEN 1.0 | 30 | 1.00 | 1.95 | 364.5 |

^{a}degree of sulfonation measured by NMR
^{b}measured at room temperature in DMAc
^{c}5% weight loss temperature in N₂

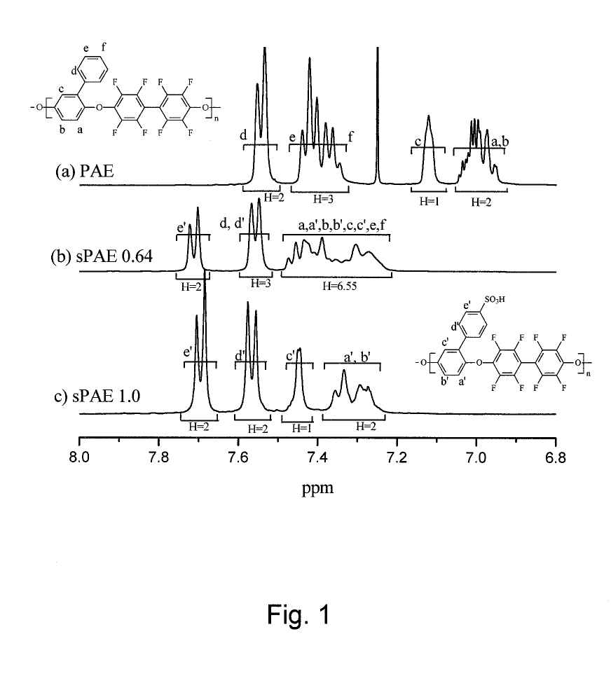

FIG. 1 shows stacked NMR spectra of (a) PAE and (c) sPAE with a DS of 1.0. The (b) spectrum of partially sulfonated copolymer is more complex because it shows a polymer with both unsulfonated and sulfonated repeat units, unlike homopolymers PAE and sPAE. The DS was determined as 0.64 from the peak intensities, as described later. The NMR spectrum of the unsulfonated PAE polymer was obtained from CDCl₃ solution whereas the more polar sulfonated polymers were prepared from DMSO-d₆ solutions; hence the chemical shift differences between the two. Nonetheless, all of the main chain ortho-oxygen aromatic protons appeared at lower frequencies due to shielding from the electron donating oxygen atoms. At the opposite end of the aromatic region are the ortho —SO₃H protons, which appear at high frequency because of the strong electron withdrawing group. The simple hydrogen spin systems facilitated peak assignment based on their multiplicity and intensity. Proton H-d′ and H-e′ of the sulfonated polymer were assigned unambiguously using 2D-HMBC. The DS was calculated by comparing the intensity of the unique sulfonated polymer's H-e′ (7.63-7.75 ppm) protons with the intensity of the remaining signals (7.20-7.63 ppm). The following mathematical formula shows how the ratio of experimental integral values can be compared with the ratio of expected number of protons per average repeat units in order to obtain the DS:

$$\begin{matrix}\frac{R 1}{R 2} = \frac{x ( 2 {He}^{′} )}{\begin{matrix}[ x ( {Ha}^{′} {b}^{′} {c}^{′} + 2 {Hd}^{′} ) ] + \\ [ ( 1 - x ) ( Habc + 2 Hd + 2 He + Hf ) ]\end{matrix}} \\ = \frac{2 x}{[ 5 x ] + [ 8 - 8 x ]} \\ = \frac{2 x}{8 - 3 x}\end{matrix} \\ ∴ x = \frac{8 R 1}{3 R 1 + 2 R 2}$$

where x=degree of sulfonation (0 to 1); R1=¹H MMR region 1 from 7.63-7.75 ppm; and, R2=¹H MMR region 2 from 7.20-7.63 ppm.

In FIG. 1, the middle spectrum had an integral value R2=9.55 when R1 was set to 2; hence the DS of 0.64. The DS of sPAE 0.55 and sPAE 1.0 was determined using the same method.

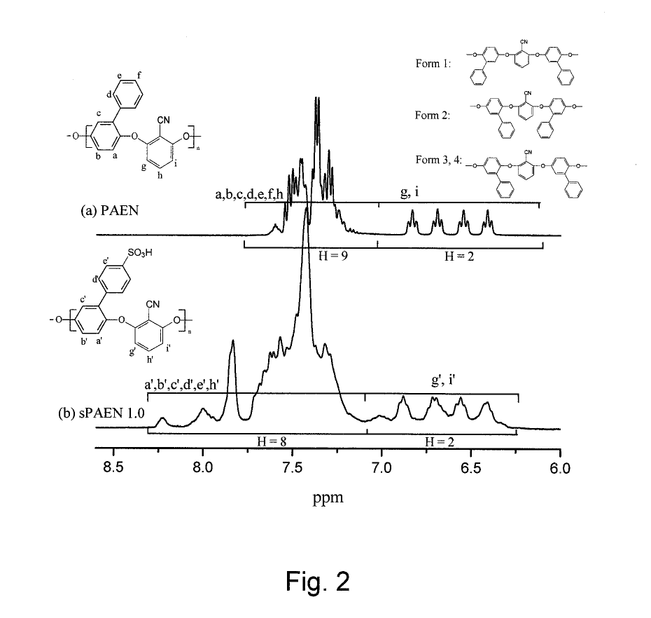

FIG. 2 shows stacked ¹H NMR spectra of unsulfonated (a) and sulfonated (b) PAEN copolymer. In this polymer, the low frequency protons were used to get an estimate of the DS. The signals from H-g,g′ and H-i,i′ appear at low frequencies because they are shielded by the two electron donating oxygen atoms. This effect is particularly strong at the oxygen ortho and para positions due to electron delocalization. Therefore H-g,g′ and H-i,i′ appear at low frequencies whereas the meta-proton H-h,h′ are not shielded as much; hence their higher chemical shift values. FIG. 2 shows that by setting the peak intensity value to 2H for the low frequency PAEN protons will result in the expected 9H for the remaining signal intensity. H-g, and H-i appear as four different signals due to the four possible repeat units in the polymer as illustrated in FIG. 2 (Forms 1-4). Any H-g or H-i protons will have equal statistical chances of having one of the four possible electronic environments around it, resulting in four signals all with the same intensities. It is the position of the pendant phenyl groups around the benzonitrile units that is responsible for this effect, which is made more complicated when sulfonic acid groups are present on the side groups. The sulfonic acid groups are in close proximity with H-g′ and H-i′ and the result is a more complex spectrum, especially when the NMR solvent used is solely DMSO-d₆. The spectrum of sPAEN shown in FIG. 2 (b) was obtained from a solvent mixture (1:1) of DMSO-d₆ (reference 2.50 ppm) and MeOD-d₄, allowing the possibility to recognize the H-g′ and H-i′ signals and set their intensity to 2H. The remaining signals integrate for 8H which suggests that exactly one hydrogen atom was substituted by a sulfonic acid group. Experience learned from previous work done by our group on these polymer systems leads us to believe that substitution occurred only at the para position of the pendant phenyl groups⁴. The theoretical IEC (meq/g) of sPAE 1.0 and sPAEN 1.0 are 1.78 and 2.73 meq/g, respectively. Table 2 shows the IEC_{W} measured experimentally by the typical titration method were in close agreement with the theoretical values.

TABLE 2
Various IEC, water uptake, and proton conductivities of membranes

| | | | | | | | | | Proton | | | |
|---|---|---|---|---|---|---|---|---|---|---|---|---|
| | | | ^{c}IECᵥ | | Water uptake | | | | Conductivity | | Methanol | |
| | ^{a}Density | ^{b}IEC_{w} | (meq./cm³) | | ^{d}wt % | | ^{e}vol % | | (mS/cm) | | permeability | ^{f} Relative |
| Copolymer | (g/cm³) | (meq./g) | dry | wet | 30° C. | 80° C. | 30° C. | 80° C. | 30° C. | 80° C. | (cm²/s) | selectivity |
| sPAE 0.55 | 1.21 | 0.98 | 1.19 | 0.97 | 18.8 | 21.0 | 22.7 | 25.4 | 36.7 | 64.1 | 2.68 × 10 [symbol] | 3.8 |
| sPAE 0.64 | 1.34 | 1.14 | 1.53 | 1.16 | 23.7 | 25.6 | 31.8 | 34.3 | 51.7 | 101.4 | 2.94 × 10 [symbol] | 4.7 |
| sPAE 1.00 | 1.39 | 1.75 | 2.43 | 1.77 | 27.0 | 32.0 | 37.5 | 44.5 | 68.2 | 135.4 | 8.98 × 10 [symbol] | 2.1 |
| sPAEN 1.0 | 1.31 | 2.71 | 3.55 | 2.55 | 30.0 | 39.6 | 39.3 | 51.9 | 81.4 | 140.1 | 7.28 × 10 [symbol] | 3.0 |
| Nafion 1135 | 1.98 | 0.90 | 1.78 | 1.29 | 19 | 28.6 | 37.6 | 56.6 | 57.1 | 125.0 | 1.55 × 10 [symbol] | 1.0 |

^{a}based on dry state
^{b}based on weight of dry membrane
^{c}based on volume of dry and/or wet membranes (IECᵥ (wet) = IECᵥ (dry)/(1 + 0.01 WU))
^{d}WU (mass %) = (W_{wet} - W_{dry})/W_{dry} × 100
^{e}WU (vol %) = ((W_{wet} - W_{dry})/δ_{w})/(W_{dry}/δₘ) × 100, (W_{wet} and W_{dry} are the weights of the wet and dry membranes, respectively; δ_{w} is the density of water (1 g/cm³), and δₘ is the membrane density in the dry state)
^{f} relative selectivity = membrane selectivity/Nafion ™ selectivity (selectivity = [proton conductivity]/[methanol permeability]) at 30° C. [symbol]
indicates data missing or illegible when filed

### Thermal and Mechanical Properties

The unsulfonated copolymers (PAE and PAEN) showed excellent thermal stability as judged by the TGA curves. The 5% weight loss temperatures of copolymer are listed in Table 1. The PAE containing DFBP shows more thermal stability than PAEN containing DFBN. The post-sulfonated derivatives had lower thermal decomposition temperatures as shown in Table 1.

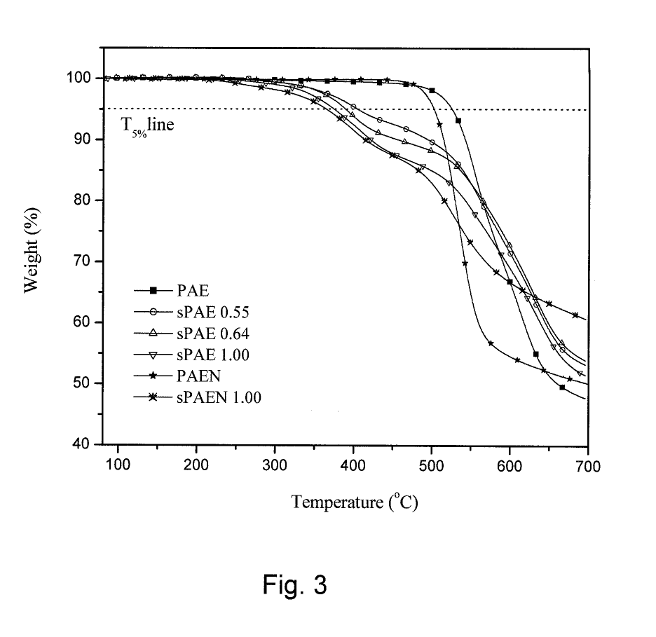

A two-step degradation profile was observed for all sulfonated copolymers in their acid form (FIG. 3). There is no weight loss up to 200° C. because all the sulfonated samples were preheated at 150° C. for 40 min to remove water molecules. In the case of the sPAE 0.55 copolymer, the first weight loss occurred above 300° C. However, the initial weight loss temperatures for copolymers having higher DS were significantly reduced, showing sPAE 0.64 (263° C.), sPAE 1.0 (241° C.), and sPAEN 1.0 (213° C.). This decomposition stage was possibly associated with the loss of bound water as well as degradation of the sulfonic acid groups. Most of the absorbed water molecules in the membrane are believed to exist in a bound state, rather than in the free molecular state.²⁵ Bound water molecules associated with the polymer chains and/or the sulfonic acid groups via hydrogen bonds may be present. Therefore, bound state water that could not be removed from the membrane after preheating at 150° C. affects the result of the TGA. The weight loss (%) between 250-450° C., principally associated with degradation of the sulfonic acid groups, increased with increasing the DS. The further weight loss stage around 500-600° C. is related to the degradation of the main chain.

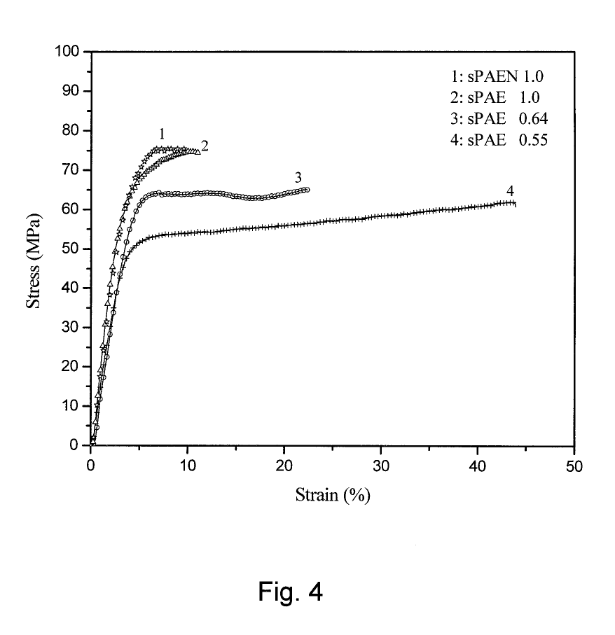

Good mechanical properties of the membrane are one of the necessary demands for their DMFC or PEMFC applications. The samples in the dry state had tensile stress at maximum load of 61-72 MPa, Young's modulus of 1.5-2.1 GPa, and elongation at break of 9.5-44% as shown in FIG. 4. Compared with the data of Nafion™ with tensile stress of 38 MPa, Young's modulus of 0.18 GPa, and elongation at break of 301.5% in the dry state¹¹, the sPAE and sPAEN materials showed higher tensile strength and the lower elongation than Nafion™.

### Membrane Properties

Table 2 compares the density, IEC, and water uptake (WU) of the sulfonated membranes and Nafion™ 1135. Density and volume-based quantities for IEC and WU on hydrocarbon-based PEMs are generally not widely reported. However, because electrochemical properties such as proton conductivity and permeability occur over length scales under operating conditions independent of mass, the changes in length scale (reflected in volume measurements) are considered to be a more appropriate comparison basis than weight-based measurements. Water uptake (weight and volume based) of PEMs is important for IEC, proton conductivity, dimensional stability, mechanical strength, and membrane-electrode compatibility of the membrane. Table 2 shows a clear trend of moderately increasing water uptake with IEC_{W} and IEC_{V}. The IEC_{V}(wet) of the sPAE series increased from 0.97 to 1.77 meq/cm³, with closely similar values for IEC_{W}. Although the sPAEN 1.0 has a high value for IEC_{V}(wet) of 2.55 meq/cm³, and IEC_{W} of 2.71 meq/g, the water uptake values were moderate and within acceptable range. The increased sulfonic acid group concentration of the dry polymer was retained after equilibration with water in these copolymer systems. In our previous study⁸ and in common with many other studies, it is often observed that hydration of copolymers having high IEC_{W} led to excessive swelling, resulting in the dilution of the ion concentration after equilibration with water. However, in the case of sPAE 1.0 and sPAEN 1.0, even when a high concentration of sulfonic acid groups was present in the dry state, it was still maintained when the membrane was equilibrated in water, because the dimensional swelling was restrained. Although the IEC of sPAE 1.0 and sPAEN 1.0 show 1.75 IEC_{W} (1.77 IEC_{V}(wet), 2.43 IEC_{V}(dry)), and 2.71 IEC_{W} (2.55 IEC_{V}(wet), 3.55 IEC_{V}(dry)), the water uptakes based on volume of sPAE 1.0 and sPAEN 1.0 are 44.5 and 51.9 vol % at 80° C., respectively, showing a similar or lower water uptake compared to Nafion™. These membranes have still good mechanical properties after the boiling water test, in spite of high IEC. We suggest that a plausible factor for the low water uptake of copolymers containing nitrile groups is the presence of strong nitrile dipole interchain interactions occurring in certain polymer structural configurations that combine to limit swelling in water^{23,26}. In addition, nitrile-sulfonic acid group also interactions appear to be important as nitrile groups have been found to associate with sulfonic acid groups through bridging water molecules in specific spectroscopic studies²⁷.

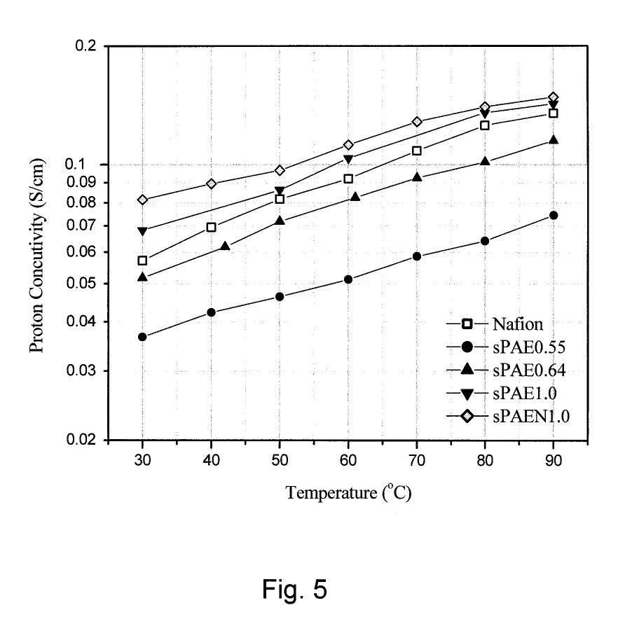

Table 2 also shows the proton conductivity of the present sPAE and sPAEN PEMs and Nafion™ that were measured on free-standing membranes. The hydrated membrane thickness and width measured at certain temperatures was used to calculate the proton conductivity. Nafion™ and sulfonated membrane were placed into the temperature controlled chamber simultaneously, and the proton conductivities of both the sulfonated membrane and Nafion™ reference were measured each time. The average proton conductivity value of Nafion™ was used in Table 2 and FIG. 5. In general, proton conductivity below 50 mS/cm can lead to significant ohmic losses under fuel cell operation. Consequently, if the proton conductivity is insufficient, ohmic losses cannot be compensated by reducing the membrane thickness due to practical considerations of membrane fabrication or mechanical properties.¹ All the sulfonated membranes in the present series had acceptable or good proton conductivity. The sPAE 1.0 and sPAEN 1.0 had excellent proton conductivities (135.4 mS/cm to 140 mS/cm), higher than that of Nafion™ (125 mS/cm) at 80° C., and generally higher in the 30° C. to 90° C. temperature range. FIG. 5 shows the increase in proton conductivity with increasing temperature, with the sPAE and sPAEN having slightly higher temperature dependence than Nafion™ on proton conductivity.

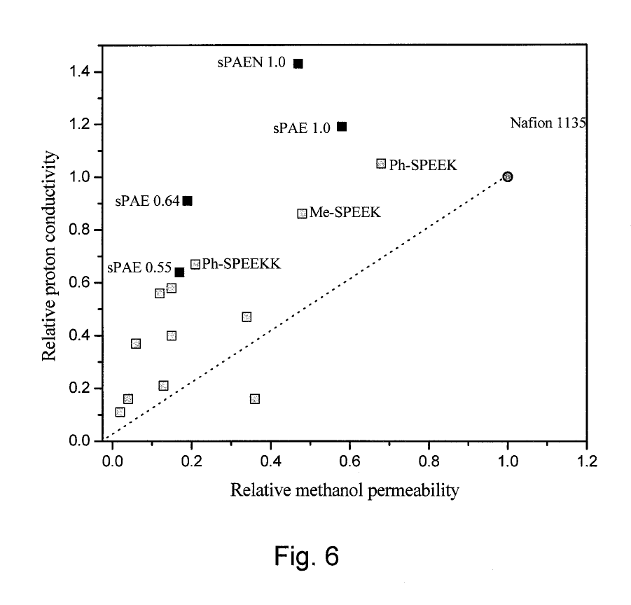

Membranes intended for DMFC must possess both high proton conductivity and be an effective barrier for methanol crossover from the anode to the cathode compartment. It is well known that Nafion™ has good proton conductivity due to strongly interconnected ionic domains structure, but it also suffers from high methanol permeability. The methanol permeabilities of the sulfonated membranes with 10% methanol concentration at room temperature were in the range of 2.68×10⁻⁷ cm²/s to 8.98×10⁻⁷ cm²/s, which is several times lower than the value for Nafion™ of 1.55×10⁸ cm²/s as listed in Table 2.⁸ Selectivity, which is the ratio of the proton conductivity to the methanol permeability, is often used to evaluate the potential performance of DMFC membranes.²⁸ As listed in Table 2, the relative selectivities of the sulfonated copolymers are higher than that of Nafion™, especially sPAE 0.64 with a high value of 4.7. Relative selectivities are a useful parameter to predict potential DMFC performance, providing the membrane has the necessary proton conductivity for low ohmic resistance. FIG. 6 shows a trade-off plot of proton conductivity versus methanol permeability relative to Nafion™. Some of the present PEMs are situated in the zone of high performance compared to our previous data^{11,29} related to polymers disclosed in PCT/CA2007/001229.

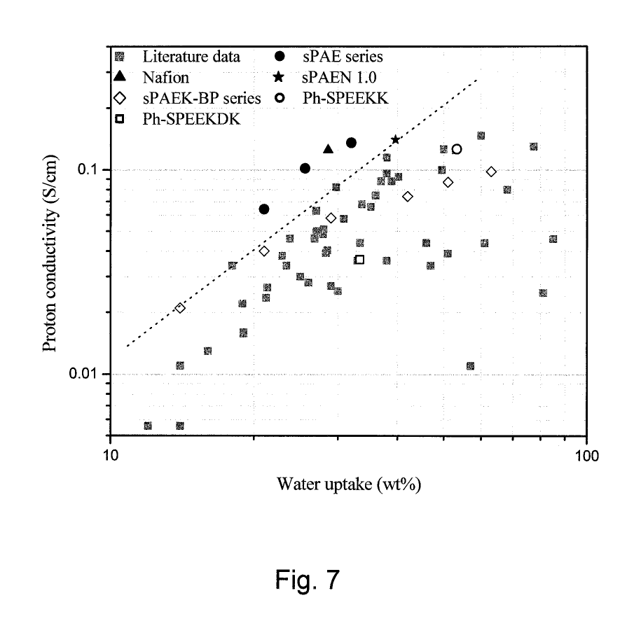

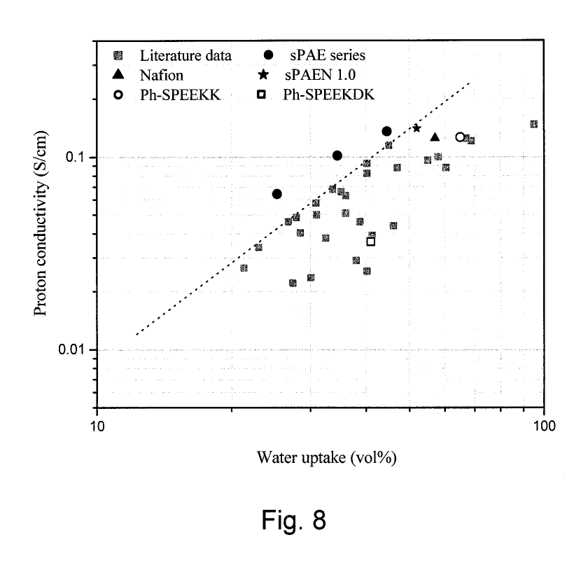

Water uptake of membranes is known to have a profound effect on proton conductivity and methanol permeability. Although literature data have been compiled for proton conductivity data versus methanol permeability, proton conductivity versus water uptake has rarely been plotted in the multitude of literature references. McGrath's group suggests that an upper bound relationship may exist, expressed by a linear log-log plot of water content versus proton conductivity of the membrane³⁶. FIG. 7 shows the conductivity of various PEM as a function of water uptake (wt %). Because density data and water uptake based on volume for the alternative polymers is not available in many cases, the water uptake data in FIG. 7 are shown on a weight basis. The data of sulfonated poly(arylene ether ketone) (sPAEK) derived from PHQ also included in FIG. 7. These sPAEKs were synthesized using 4,4′-difluorobenzophenone (DFBP), 4,4′-(hexafluoroisopropylidene) diphenol (6F-BPA), and 2-phenylhydroquinone (PHQ)^{11,24} Proton conductivity generally has a strong tradeoff in its relationship with the water uptake. Hence, target membranes with better performance should be located in the upper left-hand corner, i.e., high proton conductivity and low water uptake. As shown in FIG. 7, the sPAE series synthesized using DFBP and PHQ are located in target membrane area. However, these plots do not allow direct comparison of different membrane materials. As mentioned previously, changes in length scale (reflected in volume measurements) are considered to be a more appropriate basis for comparison, rather than weight change. Water uptake based on volume and proton conductivity was re-plotted using available published data, as shown in FIG. 8. Nafion™, with a considerably higher density than other copolymers, is shifted to slightly higher water uptake (vol. %) compared to the other membranes, when considered on a volume basis. However, the present sPAE series are still situated in the upper left-hand corner of the plot, indicating improved performance.

Generally, hydrocarbon PEMs containing sulfonic acid groups located directly on the polymer backbone achieve suitable conductivities only at high IEC, though at a penalty of high water uptake and large membrane dimensional changes, rendering them less suitable for practical PEM applications. However, compared with other sulfonated copolymers having similar proton conductivity or water uptake (vol %), the sPAE series and sPAEN 1.0 surprisingly show either better dimensional stability or higher proton conductivity, as shown in FIG. 8. The main-chains of sPAE and sPAEN copolymers are composed of poly(arylene ether) and poly(arylene ether nitrile) with high contents of fluorine or nitrile groups, respectively, while the sulfonic acid groups are attached to pendant phenyls to facilitate microphase separation from the hydrophobic polymer main chains in order to create continuous ionic-channel networks. A highly fluorinated main-chain in the sPAE series provides a high degree of chain hydrophobicity and chemical stability to the materials⁹. In our previous study²⁶, it was shown that the introduction of nitrile groups into sulfonated copolymers of specific structures reduced the water uptake (wt %) and dimensional swelling (vol %). The present sPAEN contains an unprecedented high content of phenylnitrile groups for an experimental PEM material. The sPAE series and sPAEN 1.0 copolymers show better membrane performance, indicated by high proton conductivity and low water uptake (vol %), compared with other copolymers. Especially, the sPAE series exceed the typical PEM trade-off line that shows the relationship between water uptake (vol %) and proton conductivity, as shown in FIG. 8.

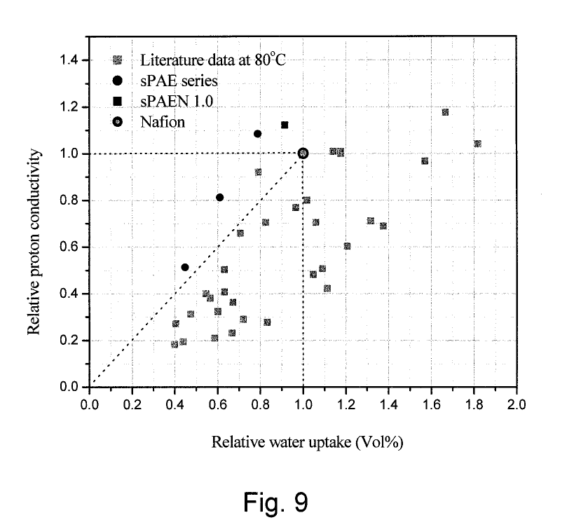

Many research groups have reported PEM materials showing high proton conductivity and lower methanol permeability on free-standing membranes compared to Nafion™ membranes. However, the cell performance or the durability data on these PEMs were not available in most cases. The origin of membrane-electrode compatibility has been a subject of significant effort within many research groups over the past few years. Nafion™-based electrodes have been optimized for performance of Nafion™ membrane in DMFC systems. Kim's group has attributed membrane-electrode interfacial resistance to differential swelling between the membrane and electrodes leading to electrode delamination¹⁹. The dimensional swelling (water uptake (vol %)) of the PEM is important for membrane-electrode compatibility. FIG. 9 shows the relative water uptake of various PEMs as a function of relative conductivity. In this study, the conductivity and water uptake (vol %) of alternative membranes have been normalized to the values for Nafion™. Nafion™ is defined here as having a relative proton conductivity and water uptake of 1. Although there is no clear guideline for maximum allowable water uptake, membranes with a high relative water uptake can result in increased difficulties in MEA fabrication, membrane-electrode interfacial resistance, membrane creep, and deformation. Although some PEM copolymers having a similar relative water uptake have up to 60% lower conductivity, while some having a similar proton conductivity have up to 80% higher water uptake, the present sPAE 1.0 and sPAEN 1.0 copolymers have higher proton conductivity and lower water uptake.

Highly fluorinated copoly(arylene ether) (PAE) and copoly(arylene ether nitrile) (PAEN) with high nitrile content, containing pendant phenyl rings were synthesized. Sulfonic acid groups were introduced exclusively on the para-position of pendant phenyl rings by post sulfonation. The resulting sPAE and sPAEN sulfonated copolymers having a degree of sulfonation of 1.0 had high proton conductivity, acceptable volume-based water uptake, the high relative selectivity (derived from proton conductivity and methanol permeability). The surprisingly excellent combination of inexpensive monomers, simple preparative methods, high thermal stability, high proton conductivity, high relative selectivity, relatively low water uptake (vol %) make sulfonated polymers of the present invention, especially sPAE 1.0 and sPAEN 1.0, very attractive as potential PEM materials for fuel cell applications.

### REFERENCES

The contents of the entirety of each of which are incorporated by this reference.
1. Kim, Y. S.; Pivovar, B. S. Advances in Fuel Cells, 2007, Vol 1, 187-234.
2. Hickner, M.; Ghassemi, H.; Kim, Y. S.; Einsla, B.; McGrath, J. E. Chem. Rev. 2004, 104, 4587.
3. Kim, Y. S.; Einsla, B.; Sankir, M.; Harrison, W.; Pivovar, B. S. Polymer 2006, 47, 4026.
4. Gao, Y.; Robertson, G. P.; Guiver, M. D.; Mikhailenko, S. D.; Li, X.; Kaliaguine, S. Macromolecules 2005, 38, 3237.
5. Li, Z.; Ding, J.; Robertson, G. P.; Guiver, M. D. Macromolecules 2006, 39, 6990.
6. Pang, J.; Zhang, H.; Li, X.; Jiang, Z. Macromolecules 2007, 40, 9435.
7. Kreuer, K. D. J. Membr. Sci. 2001, 185, 29.
8. Kim, D. S.; Robertson, G. P.; Guiver, M. D. Macromolecules 2008, 41, 2126.
9. Norsten, T. B.; Guiver, M. D.; Murphy, J.; Astill, T.; Navession, T.; Holdcroft, S.; Frankamp, B. L.; Rotello, V. M.; Ding, J. Adv. Funct. Mater. 2006, 16, 1814.
10. Li, Z.; Ding, J,; Robertson, G. P.; Guiver, M. D, Macromolecules 2006, 39, 6990.
11. Liu, B; Robertson, G. P; Kim, D. S; Guiver, M. D; Hu, W; Jiang, Z. Macromolecules 2007, 40, 1934.
12. Yang, B.; Manthiram, A. Electrochem. Solid-State Lett., 2003, 6, A229.
13. Miyatake, K.; Zhou, H.; Matsuo, T.; Uchida, H.; Watanabe, M. Macromolecules, 2004, 37, 4961.
14. Harrison, W. L.; Hickner, M. A.; Kim, Y. S.; McGrath, J. E. Fuel Cells, 2005, 5, 201.
15. Fu, Y. Z.; Manthiram, A. J. Power Sources, 2006, 157, 222.
16. Kim, Y. S.; Pivovar, B.S. in 208^{th} Meeting of the Electrochemical Society, Abs no. 1215, Los Angeles 2005.
17. Pivovar, B. S.; Kim, Y. S. J. Electrochem. Soc., 2007, 154, B739.
18. Goodwin, A. A.; Mercer, F. W.; Mckenzie, M. T. Macromolecules. 1997, 30, 2767.
19. Lee, H. C.; Hong, H. S.; Kim, Y. M.; Choi, S. H.; Hong, M. Z.; Lee, H. S.; Kim, K. Electrochimica Acta. 2004, 49, 2315.
20. Kim, D. S.; Robertson, G. P.; Guiver, M. D.; Lee, Y. M. J. Membr Sci. 2006, 281, 111.
21. Sumner, M. J.; Harrison, W. L.; Weyers, R. M.; Kim, Y. S.; McGrath, J. E.; Riffle, J. S.; Brink, A.; Brink, M. H. J. Membr. Sci., 2004, 239, 199.
22. Gao, Y.; Robertson, G. P.; Kim, D. S.; Guiver, M. D.; Mikhailenko, S. D.; Li, X.; Kaliaguine, S. Macromolecules, 2007, 40, 1512.
23. Kim, Y. S.; Kim, D. S.; Liu, B.; Guiver, M. D.; Pivovar, B. S. J. The Electrochem. Soc. 2008, 155 (1), B21.
24. Jeong, M. H.; Lee, K. S.; Hong, Y. T.; Lee, J. S. J. Membr. Sci. 2008, 314, 212.
25. Honma, I.; Nishikawa, O.; Sugimoto, T.; Nomura, S.; Nakajima, H. Fuel Cells. 2002, 1, 52.
26. Kim. D. S.; Kim. Y. S.; Guiver, M. D.; Pivovar, B. S.; J. Membr Sci., in press 2008.
27. Saha, S.; Hamaguchi, H. J. Phy. Chem. B., 2006, 110, 2777.
28. Kim, D. S.; Shin, K. H.; Park, H. B.; Chung, Y. S.; Nam, S. Y.; Lee, Y. M. J. Membr. Sci. 2006, 278, 428.
29. Liu, B.; Kim, D. S.; Guiver, M. D.; Kim, Y. S.; Pivovar, B. S. Sulfonated poly(aryl ether)-type polymers as proton exchange membranes: synthesis and performance, in “Membranes for Energy Conversion”, volume 2 of “Membrane Technology” series, K. -V. Peinemann, S. P. Nunes, Eds., Wiley—VCH, Chapter 1, pp. 1-45, 2008.
30. Xing, P.; Robertson, G. P.; Guiver, M. D.; Mikhailenko, S. D.; Kaliaguine, S. J. Polym. Sci., Part A. 2004, 42, 2866.
31. Xing, P.; Robertson, G. P.; Guiver, M. D.; Mikhailenko, S. D.; Kaliaguine, Macromolecules, 2004, 37, 7960.
32. Liu, B.; Kim, D. S.; Murphy, J.; Robertson, G. P.; Guiver, M. D.; Mikhailenko, S. D.; Kaliaguine, S.; Sun, Y. M.; Liu, Y. L.; Lai, J. Y. J. Membr. Sci. 2006, 280, 54.
33. Wang. Z.; Li, X.; Zhao, C.; Ni, H.; Na. H, J. Power. Sources. 2006, 160, 969.
34. Wang, A.; Ni, H.; Zhao, C.; Li, X.; Zhang, G.; Shao, K.; Na, H. J. Membr. Sci. 2006, 285, 239.
35. Pang, J.; Zhang, H.; Li, X.; Jiang, Z. Macromolecules 2007, 40, 9435.
36. Robeson, L. M.; Hwu, H. H.; McGrath, J. E. J. Membr. Sci. 2007, 302, 70.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

1. A sulfonated polymer of formula (I) or a salt thereof: 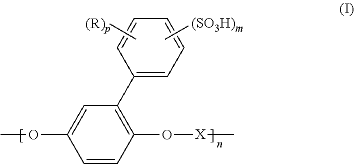
wherein X is 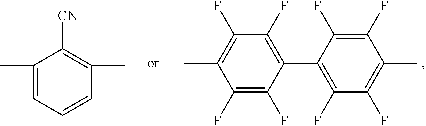
R is hydrogen or an organic moiety, n is an integer from 10 to 10,000, p is 1 or 2, and m is 0 or 1 for a particular monomer unit such that the polymer has a degree of sulfonation of 0.50 or greater.

2. The polymer according to claim 1, wherein R is hydrogen.

3. The polymer according to claim 1, wherein the degree of sulfonation is 0.60 or greater.

4. The polymer according to claim 1, wherein the —SO₃H group is in para position for monomer units in which m is 1.

5. The polymer according to claim 1, having a number average molecular weight (Mn) in a range of from about 1,000 to about 1,000,000.

6. The polymer according to claim 1, having a number average molecular weight (Mn) in a range of from about 5,000 to about 500,000.

7. The polymer according to claim 1, having a methanol permeability of 1.0×10⁻⁶ cm²/s or less, a relative selectivity of 2.0 or greater, a water uptake of 45 wt % or less at 80° C., a proton conductivity at 30° C. of 60 mS/cm or greater, or any combination thereof.

8. The polymer according to claim 1, having water uptake-based relative selectivity of from 0.75 to 1.00 at 80° C.

9. The polymer according to claim 1, having a water uptake of 45 wt % or less at 80° C. and a proton conductivity of about 80 mS/cm or greater at 80° C.

10. The polymer according to claim 1, having a relative selectivity of 3.0 or greater.

11. A proton exchange membrane comprising a sulfonated poly(aryl ether) as defined in claim 1.

12. The proton exchange membrane of claim 11, wherein the proton exchange membrane is in a fuel cell.

13. An ionomer catalyst binder for a fuel cell comprising a sulfonated poly(aryl ether) as defined in claim 1.
